(19) United States
(12) Patent Application Publication
(10) Pub. No.: US 2024/0110419 A1
(43) Pub. Date: Apr. 4, 2024

(54) REVERSIBLE BIFOLD DOOR ROLLER ASSEMBLY

(71) Applicant: MAMMOTH INDUSTRIES PTY LTD, THOMASTOWN VICTORIA (AU)

(72) Inventors: Craig Lang, Thomastown Victoria (AU); Matthew Keen, Thomastown Victoria (AU)

(21) Appl. No.: 18/471,657

(22) Filed: Sep. 21, 2023

(30) Foreign Application Priority Data
Sep. 29, 2022 (AU) 2022902822

(51) Int. Cl. E05D 15/26; E05D 3/02; E05D 7/00; E06B 3/48

(52) U.S. Cl. CPC E05D 15/264; E05D 3/02; E05D 7/0027; E06B 3/481; E05Y 2201/684; E05Y 2201/688; E05Y 2600/12; E05Y 2600/324; E05Y 2600/46; E05Y 2900/132

(57) ABSTRACT

An apparatus for mounting a bifold door panel, and allowing the panel to run on a track. The apparatus has a trolley that runs within the track and a vertical elongate member that is axially movable relative to the trolley. A hinge or hinge portion is mounted on the elongate member, and a first support is disposed between the trolley and the hinge or hinge portion. The first support functions to support the hinge or hinge portion against a compression force arising from the bifold door panel when the apparatus is mounted on a top region of the panel. A second support is disposed at or toward the terminus of the elongate member and distal to the trolley. The second support functions to support the hinge or hinge portion against a compression force arising from the bifold door panel mounted thereon when mounted on a bottom region of the panel.

The present invention relates generally to hardware used in the mounting of door panels on a track, such as occurs with bifold doors More particularly, the invention is directed to a bifold door mount comprising a trolley configured to be used as either a top-mount or a bottom-mount.

### BACKGROUND TO THE INVENTION

Bifold doors typically consist of two door panels, which are foldable by way of connecting hinges. Depending on the configuration, these panels can be folded in one direction or even in both directions. Bifold doors are commonly configured to have an active door, which can be opened without opening the entire door system.

In terms of mounting, bifold systems typically comprise a track at the top or bottom of the door frame functioning to guide and support the door panels. A rolling trolley of some description is fixed to the bifold door, the trolley rolling within the track. Generally, the system provides for some means of vertically adjusting the height the bifold door sits above and/or below a track.

Where the door is top-mounted, the trolley rollers roll along a track at the top of the frame. In this arrangement, the door essentially hangs from the top track. In a bottom-mount arrangement, the trolley rolls along a track at the bottom of the frame with the panel bearing downwardly on the trolley.

The decision as to whether use a top or bottom-mounting approach depends on a number of factors including the strength of the door frame lintel, the possibility of dirt accumulating in a bottom track, the weight of the door etc. Once the decision is made as to which mounting approach is implemented, the correct type of hardware (i.e. suitable for top-mount or bottom-mount) must be selected and carried to the installation site.

On some occasions, the decision as to whether a top-mount or bottom-mount approach is used will be made at the time of installation. The day of installation may be the first time the installer has assessed the door frame and the general environment of the installation. In that circumstance the installer must carry both top and bottom-mounting specific hardware.

On other occasions, the installer has previously decided on a top or bottom-mount and has carried the appropriate hardware to the installation site. Once at the site, some unforeseen circumstance may force a change in mounting strategy, and in which case the installer will need to cease work and source different mounting hardware.

The need to keep separate inventory of top and bottom-mounting hardware is also undesirable for the supplier. In some circumstances, inventory for one type of hardware may not be readily sold, thereby creating the need to hold excess stock. Moreover, online ordering of bifold door mounting hardware is complicated by the need for a customer to appreciate that two different versions of the hardware are offered, and the correct version for the installation must be selected.

For the manufacturer, it is necessary to establish and maintain two distinct production lines to produce each of top and bottom-mounting hardware. This adds to costs given the need for separate tooling, fabrication of components, and training staff in assembly methods.

It is an aspect of the present invention to provide an improvement to prior art bifold door mounting hardware. It is a further aspect of the present invention to provide a useful alternative to prior art bifold door mounting hardware.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides an apparatus operable as both a top-mount and a bottom-mount for a bifold door panel(s), the apparatus comprising:
a trolley comprising rolling means and configured to roll substantially horizontally within a track
an elongate member being substantially vertically orientated and axially movable relative to the trolley,
a hinge or hinge portion mounted on or about the elongate member, and
a first support means disposed between the trolley and the hinge or hinge portion, the first support means being configured so as to directly or indirectly support the hinge or hinge portion against a compression force arising from a bifold door mounted thereon when the apparatus is mounted on or about a top region of the bifold door, and
a second support means disposed at or toward the terminus of the elongate member distal to the trolley, the second support means being configured so as to directly or indirectly support the hinge or hinge portion against a compression force arising from a bifold door mounted thereon when the apparatus is mounted on or about a bottom region of the bifold door.

In one embodiment of the first aspect, the first support means is positioned along the elongate member such that the hinge or hinge portion is sandwiched between the first and second supports.

In one embodiment of the first aspect, the hinge or hinge portion bear directly or indirectly on the first support means when the apparatus is used as a bottom-mount.

In one embodiment of the first aspect, the hinge or hinge portion bear directly or indirectly on the second support means when the apparatus is used as a top-mount.

In one embodiment of the first aspect, the elongate member is threaded

In one embodiment of the first aspect, the first support means is movable along the elongate member.

In one embodiment of the first aspect, the first support means inherently retains a position along the elongate member or is lockable at a position along the elongate member.

In one embodiment of the first aspect, the first support means is a nut windable along the elongate member.

In one embodiment of the first aspect, the nut is windable so as to bear directly or indirectly against the hinge or hinge portion.

In one embodiment of the first aspect, the apparatus comprises a washer disposed between the nut and the hinge or hinge portion.

In one embodiment of the first aspect, the second support means is an expanded terminal portion of the elongate member distal to the trolley.

In one embodiment of the first aspect, the elongate member is threaded and the trolley or a structure associated with the trolley comprises a complimentary thread so as to allow the elongate member to be axially movable relative to the trolley by winding, thereby allowing for vertical adjustment of a bifold door mounted on the hinge or hinge portion.

In a second aspect, the present invention provides a bifold door having fitted thereto the apparatus of any embodiment of the first aspect.

In a third aspect, the present invention provides a track operable as both a top-mount track and a bottom-mount track for the bifold door of the second aspect, the track comprising a channel configured to capture the one or more rolling means of the trolley whether used as a top-mount track or a bottom-mount track.

In one embodiment of the third aspect, the track comprises first and second opposing rolling surfaces configured to alternately allow the rolling means of the apparatus of any embodiment of the first aspect to roll on the first rolling surface when the track is in a first orientation, an allow the rolling means of the apparatus to roll on the second rolling surface when the track is in a second orientation, wherein the second orientation is about 180 degrees to the first orientation.

In a fourth aspect, the present invention provides the combination of the apparatus of any one of any embodiment of the first aspect, with the track of an embodiment of the third aspect.

In one embodiment of the fourth aspect, the combination is embodied in a kit of parts presented in a vendible package, the package comprising instructions on a method of installing a bifold door using the combination.

In a fifth aspect, the present invention provides a method of installing a bifold door in a doorway, the method comprising:
providing a bifold door,
fitting the apparatus of any embodiment of the first aspect in a first orientation to an upper portion of the bifold door, and
fitting the apparatus of any embodiment of the first aspect in a second orientation to a lower portion of the bifold door,
wherein the second orientation is about 180 degrees to the first orientation.

In one embodiment of the fifth aspect, the method comprises:
fitting the track of any embodiment of the third aspect in a first orientation to an upper portion of the doorway, and
fitting the track of any embodiment of the third aspect in a second orientation to a lower portion of the doorway,
wherein the second orientation is about 180 degrees to the first orientation.

### BRIEF DESCRIPTION OF THE FIGURES

FIG. 1 illustrates lateral view of a preferred bifold door mounting apparatus according to the present invention, in exploded form to show the individual components.

FIG. 2A illustrates a lateral view of the apparatus of FIG. 1, in assembled form and orientated as for a bottom-mount application.

FIG. 2B illustrates an upper perspective view of the apparatus of FIG. 2A, more clearly showing the hinge leaves.

FIG. 3A illustrates in lateral view the apparatus of FIG. 2A, although inverted and therefore orientated as for a top-mount application.

FIG. 3B illustrates an upper perspective view of the apparatus of FIG. 3A, more clearly showing the hinge leaves.

FIG. 4 illustrates in lateral view the apparatus orientated as shown in FIG. 2A and FIG. 2B as mounted on the bottom edge of a bifold door panel, the rollers of the apparatus rolling on a track installed into the bottom of a door frame.

FIG. 5 illustrates in lateral view the apparatus orientated as shown in FIG. 3A and FIG. 3B as mounted on the top edge of a bifold door panel, the rollers of the apparatus rolling on a track installed into the top of a door frame.

Unless otherwise indicated herein, features of the drawings labelled with the same numeral are taken to be the same features, or at least functionally similar features, when used across different drawings.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

As used herein, positional terms such as “lateral”, “across”, “above”, “below”, “higher”, “lower”, “upward”, “downward”, “plan view” and the like are to be considered with reference to a bifold door and associated hardware (mounting apparatus and track) as used in a normal vertical installation.

The present invention is predicated at least in part on the inventors' discovery that a bifold door mount can be used as both a top-mount and a bottom-mount where the hinge is flanked by first and second support means. Accordingly, in one aspect the present invention provides a bifold door mounting apparatus operable as both a top-mount and a bottom-mount for a bifold door panel(s), the apparatus comprising: a trolley comprising rolling means and configured to roll substantially horizontally within a track, an elongate member being substantially vertically orientated and axially movable relative to the trolley, a hinge or hinge portion mounted on or about the elongate member, and a first support means disposed between the trolley and the hinge or hinge portion, the first support means being configured so as to directly or indirectly support the hinge or hinge portion against a compression force arising from a bifold door mounted thereon when the apparatus is mounted on or about a top region of the bifold door, and a second support means disposed at or toward the terminus of the elongate member distal to the trolley, the second support means being configured so as to directly or indirectly support the hinge or hinge portion against a compression force arising from a bifold door mounted thereon when the apparatus is mounted on or about a bottom region of the bifold door.

The first support means may be disposed between the trolley and the hinge, and supports the hinge leaves when the apparatus is used as a bottom mount. In the absence of the first support, the hinge leaves would be subject to the weight of the attached door and would accordingly slide downwardly along the elongate member until the door settles on the floor or sill

The function of the first support means may be considered by reference to the distribution and transfer of load through the bifold door system. Load arising from supported bifold door panels is directed to the attached hinge leaves, and then to the first support means. The first support means transfers load to the elongate member to which it is connected. Load is transferred from the elongate member to the trolley, and from the trolley wheels to the track. The track is mounted on a door frame or directly onto the floor, and accordingly load is ultimately directed to the floor. It will be understood that in the foregoing explanation load may be transferred directly between components, or in some instances via intermediate structures such as washers, mounts, collars, spacers and the like. In any event, the load of the panel is disseminated through all components so the panels remain in equilibrium via the bottom hardware assembly.

In some embodiments the first support means is movable along the elongate member so as to adjust the bifold doors upwardly and downwardly to cater for any imperfections in the building or construction of the bifold. Adjustment may be formed while the first support means has a door panel bearing downwardly thereon, thereby allowing for accurate vertical positioning of the panel. The first support means may inherently remain in place along the elongate member, with an exemplary embodiment being a nut (being a species support means) windable along a threaded member (being a species of elongate member.

The second support means is disposed at the other end of the hinge, and functions to support the hinge (i.e. to prevent uncontrolled downward movement) when the apparatus is inverted and used as a top-mount.

Accordingly, the apparatus can be used as both a top and bottom-mount whilst still preventing negative effects on the hinge which the door is mounted on.

One of the support means at least is adjustable along the elongate member so as to effective capture or sandwich the hinge between the two support means. This generally secures the hinges against any movement (upward or downward), and is a preferred means of implementation.

The invention also provides a track to be used on combination with the present apparatus, the track being useful as both a head track (i.e. installed at the top of a door frame) and a sill (i.e. installed at the bottom of a door frame).

The present invention therefore allows for a single mount and a single track to be used irrespective of whether the bifold door is to be top or bottom mounted.

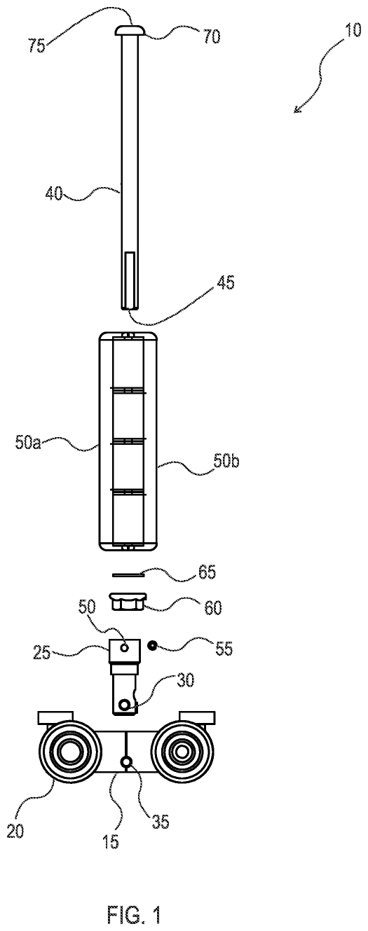

To further describe the invention, reference is made to the presented embodiments illustrated in the accompanying drawings. FIG. 1 shows an exploded view of an apparatus (10) for mounting a bifold door panel (shown in following drawings, marked 200). The apparatus is orientated in FIG. 1 as for mounting at the bottom of a bifold door.

The apparatus (10) comprises a trolley (15) having rollers (one marked 20), which as will be explained infra roll in a track installed in a door frame.

The trolley body comprises a space configured to receive the collar (25). The collar (25) has a protrusion (30) which is in register and is received by the aperture (35) so as to prevent mutual relative movement of the components.

A threaded axle (40) (being a species of elongate member) is received into a threaded space within the collar (25). The axle (40) comprises an axial cavity (45) of hexagonal cross-section and configured to receive an Allen key or similar therein. Axial rotation of the axle (40) by an installer moves the axle (40) upwardly and downwardly so as to adjust the height of a bifold door mounted on the apparatus (10).

The collar (25) has an aperture (50) to receive a locking screw (55). When the height adjustment has been made, the locking screw (55) is wound inwardly so as to contact the axle (40) and prevent further rotation of the axle (40) thereby maintaining the bifold door at the desired height.

Hinge leaves (50a, 50b) are mounted on the axle (40), each of the leaves being configured to be fixed (typically by screws) to adjacent panels of a bifold door.

A support nut (being a species of first support means) (60) is windable along the axle (40) to a position where the washer (65) contacts the lower edge (as drawn) of the hinge leaves ((50a, 50b). When the apparatus (10) is used as a bottom-mount, the support nut (60) functions to support the hinge leaves, as will be more fully described infra.

A ledge (70) (being a species of second support means) is formed at the upper terminus (as drawn) of the axle (40). When the apparatus (10) is used as a top-mount (i.e. inverted from the orientation shown in FIG. 1), the ledge (60) functions to support the hinge leaves, as will be more fully described infra. Also at the terminus of the axle (40) is a cavity (75) of hexagonal cross-section used by the installer to adjust the height of the bifold door as explained supra for cavity (45).

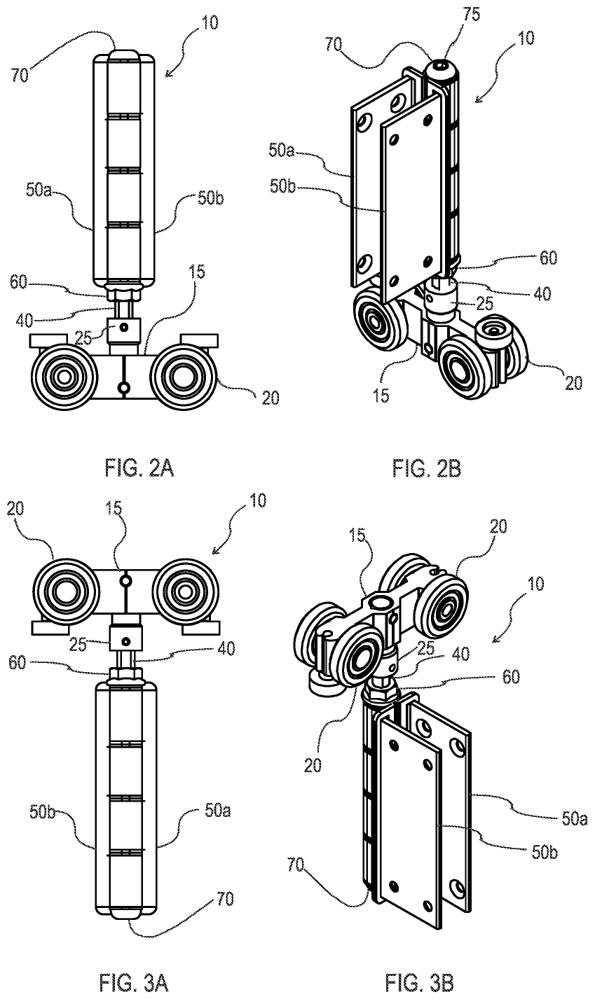

Reference is made to FIG. 2A and FIG. 2B showing the apparatus (10) of FIG. 1 in assembled form and orientated for use as a bottom-mount. Although the bifold door panels are not drawn, it will be clear that the weight of each panel would bear on hinge leaves (50a, 50b). The hinge leaves (50a, 50b) are mounted on the axle (40) and in the absence of support from beneath by way of the nut (60) and washer (65) would deform, especially where the door panel has significant mass. The nut (60) and washer (65) assume the load and form a load path extending downwardly through the axle (40) and onto the collar (25) and trolley (15). By this arrangement, the hinges are supported, and instead transfer load to the washer (65) and then the nut (60).

Reference is made to FIG. 3A and FIG. 3B showing the apparatus (10) of FIG. 1 in assembled form and orientated for use as a top-mount. Although the bifold door panels are not drawn, it will be clear that the ledge (70) functions to support the hinge (50a, 50b). In that regard, the ledge (70) performs a similar function to the nut (60). While a support nut and washer is shown in FIGS. 3A and 3B, these are not required in the orientation as drawn since support is provided by the ledge (70). A nut may nevertheless be presented to allow for the apparatus to be used as either a top or bottom mount.

As will be now appreciated, by the use of first and second supporting means a single apparatus is capable of functioning as both a top-mount and a bottom-mount. To the best of Applicant's knowledge, no such contrivance is known in the art.

The first support means may be provided by a contrivance other than a nut and washer. Preferably, the first support means is movable along the axle so as to be capable of securely sandwiching the hinge between it and the second support means. In this way, the hinge is protected against any untoward forces irrespective of whether the apparatus is used as a top-mount or a bottom-mount given that the both support means are in contact with the hinge. An example of an alternative species of a first supporting means is a slidable collar with a locking screw. In a further example, the axle may have a series of transaxial apertures long its axis, with a pin insertable through a desired aperture, the pin functioning to support the hinge in much that same way as the nut of the drawn embodiment.

In some embodiments, the first supporting means is stationary, and may be formed as a ledge disposed at a desired point along the axle length, the ledge functioning in much the same way as the terminal ledge in the drawn embodiment.

The present invention provides also a bifold door track that may be used with the mounting apparatuses described herein. As for the apparatus, the track is configured so as to operate as both a top-mounted track (i.e. installed as a head track in an upper region of a door frame) and a bottom-mounted track (i.e. installed as a sill track in a lower region of a door frame).

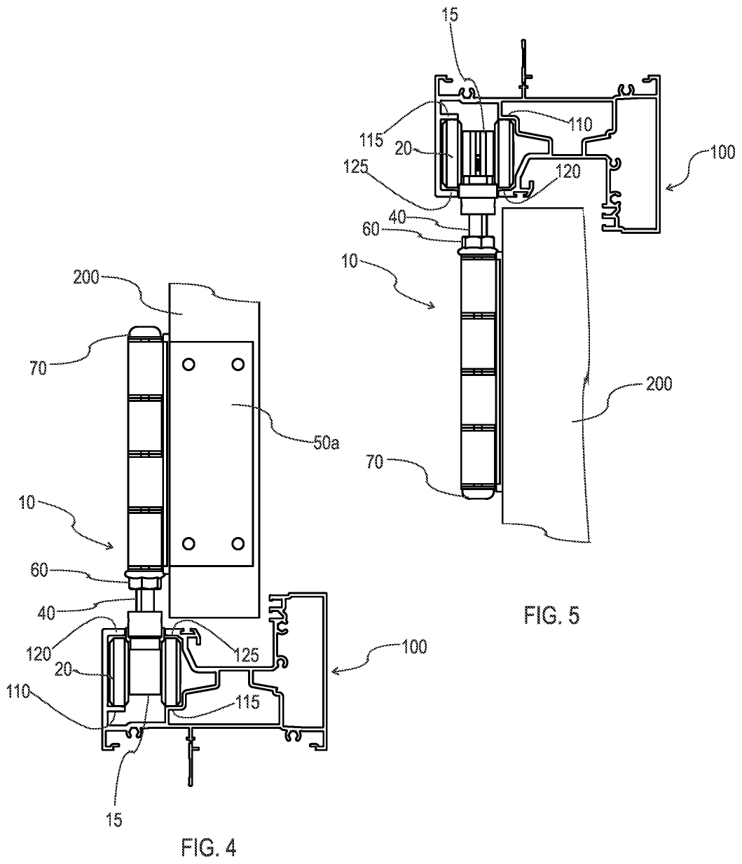

Reference is now made to FIG. 4 showing a preferred track (100) that is bottom-mounted, and FIG. 5 showing the same track but inverted for use in top-mounted track.

The rollers (20) roll within a channel defined by the rolling surfaces (110, 115, 120, 125). As shown in FIG. 4, when functioning as a bottom-mounted track the rollers (20) roll on the roller surfaces (100) and (115), but do not contact surface (120) or (125). Conversely when functioning as a top-mounted track (FIG. 5) the rollers (20) roll on the roller surfaces (120) and (125), but do not contact surface (110) or (115).

Thus, the track (100) is unique in that it comprises opposing rolling surfaces that are configured to provide rolling surfaces in a first orientation, and then a second orientation at 180 degrees to the first orientation. In both orientations the rollers are essentially captured within a channel defined by the rolling surfaces (110, 115, 120, 125). By this arrangement, a sliding door may be either supported by, or hung from, the track.

A track of the present invention may be fabricated by a plastic extrusion process, as is known for that purposed in the art.

The provision of a single track that can be mounted at both upper and lower regions of a door frame for a bifold door addresses the same problems discussed herein with regard to the door mounting hardware.

The apparatus (10) is shown being fixed to a bottom region of a bifold door (200) (FIG. 4) and fixed to a top region (FIG. 5) of a bifold door (200).

In addition to a track upon which the door is supported or hung from, a bifold door installation will typically employ a guide track at the opposite (free) end of the door. The guide track receives a guide member extending from the free end of the bifold door and into the guide track. The track of the present invention may further function to operate as a guide track, however that is not an essential feature of the invention.

Those skilled in the art will appreciate that the invention described herein is susceptible to further variations and modifications other than those specifically described. It is understood that the invention comprises all such variations and modifications which fall within the spirit and scope of the present invention.

Accordingly, the spirit and scope of the present invention is not to be limited by the foregoing examples, but is to be understood in the broadest sense allowable by law.

1. Apparatus operable as both a top-mount and a bottom-mount for a bifold door panel(s), the apparatus comprising:
a trolley configured to roll substantially horizontally within a track,
an elongate member being substantially vertically orientated and axially movable relative to the trolley,
a hinge or hinge portion mounted on or about the elongate member,
a first support disposed between the trolley and the hinge or hinge portion, the first support being configured so as to directly or indirectly support the hinge or hinge portion against a compression force arising from a bifold door mounted thereon when the apparatus is mounted on or about a top region of the bifold door, and
a second support disposed at or toward a terminus of the elongate member distal to the trolley, the second support being configured so as to directly or indirectly support the hinge or hinge portion against a compression force arising from a bifold door mounted thereon when the apparatus is mounted on or about a bottom region of the bifold door.

2. The apparatus of claim 1, wherein the first support is positioned along the elongate member such that the hinge or hinge portion is sandwiched between the first and second supports.

3. The apparatus of claim 1, wherein the hinge or hinge portion bear directly or indirectly on the first support when the apparatus is used as a bottom-mount.

4. The apparatus of claim 1, wherein the hinge or hinge portion bear directly or indirectly on the second support when the apparatus is used as a top-mount.

5. The apparatus of claim 1, wherein the elongate member is threaded.

6. The apparatus of claim 1, wherein the first support is movable along the elongate member.

7. The apparatus of claim 6, wherein the first support inherently retains a position along the elongate member or is lockable at a position along the elongate member.

8. The apparatus of claim 1, wherein the first support is a nut windable along the elongate member.

9. The apparatus of claim 8, wherein the nut is windable so as to bear directly or indirectly against the hinge or hinge portion.

10. The apparatus of claim 8, comprising a washer disposed between the nut and the hinge or hinge portion.

11. The apparatus of claim 1, wherein the second support is an expanded terminal portion of the elongate member distal to the trolley.

12. The apparatus of claim 1, wherein the elongate member is threaded and the trolley or a structure associated with the trolley comprises a complimentary thread so as to allow the elongate member to be axially movable relative to the trolley by winding, thereby allowing for vertical adjustment of a bifold door mounted on the hinge or hinge portion.

13. A bifold door comprising:
at least one panel; and
a mount fitted to the panel at either a top region or a bottom region of the at least one panel, the mount comprising:
a trolley configured to roll substantially horizontally within a track,
an elongate member being substantially vertically orientated and axially movable relative to the trolley,
a hinge or hinge portion mounted on or about the elongate member,
a first support disposed between the trolley and the hinge or hinge portion, the first support being configured so as to directly or indirectly support the hinge or hinge portion against a compression force arising from the bifold door mounted thereon when the mount is mounted on or about the top region of the bifold door, and
a second support disposed at or toward a terminus of the elongate member distal to the trolley, the second support being configured so as to directly or indirectly support the hinge or hinge portion against a compression force arising from a bifold door mounted thereon when the mount is mounted on or about the bottom region of the bifold door.

14. A bifold door installation comprising:
a bifold door comprising:
at least one panel; and
a mount fitted to the panel at either a top region or a bottom region of the at least one panel, the mount comprising:
a trolley configured to roll substantially horizontally within a track,
an elongate member being substantially vertically orientated and axially movable relative to the trolley,
a hinge or hinge portion mounted on or about the elongate member,
a first support disposed between the trolley and the hinge or hinge portion, the first support being configured so as to directly or indirectly support the hinge or hinge portion against a compression force arising from the bifold door mounted thereon when the mount is mounted on or about the top region of the bifold door, and
a second support disposed at or toward a terminus of the elongate member distal to the trolley, the second support being configured so as to directly or indirectly support the hinge or hinge portion against a compression force arising from a bifold door mounted thereon when the mount is mounted on or about the bottom region of the bifold door; and
the track, which comprises a channel configured to capture one or more rollers of the trolley.

15. The bifold door installation of claim 14, wherein the track comprises first and second opposing rolling surfaces configured to alternately allow the rollers of the apparatus to roll on the first rolling surface when the track is in a first orientation, and allow the one or more rollers of the apparatus to roll on the second rolling surface when the track is in a second orientation, wherein the second orientation is about 180 degrees to the first orientation.
